(19) United States
(12) Patent Application Publication
(10) Pub. No.: US 2008/0301317 A1
(43) Pub. Date: Dec. 4, 2008

(54) Method of Multiple File Streaming Service Through Playlist in Mobile Environment and System Thereof

(75) Inventors: Jaeyong Lee, Seoul (KR); Jong-Sung Yoon, Seoul (KR)

Correspondence Address: SEED INTELLECTUAL PROPERTY LAW GROUP PLLC, 701 FIFTH AVE, SUITE 5400, SEATTLE, WA, 98104, US

(73) Assignee: Vidiator Enterprises Inc., Nassau, New Providence (BS)

(21) Appl. No.: 11/884,109

(22) PCT Filed: Feb. 10, 2006
(86) PCT No.: PCT/US06/04896

§ 371 Date: Jul. 15, 2008

(30) Foreign Application Priority Data
Feb. 11, 2005 (KR) 10-2005-0011679

(51) Int. Cl. H04L 29/06

(52) U.S. Cl. 709/231

(57) ABSTRACT

A method and system of streaming content media files uses a Portable Terminal. In the event of streaming multiple content files in a mobile environment, the method combines multiple content files into one streaming file through the Playlist Generator provided for the Streaming Server and then streams the entire file at once to a Portable Terminal in order to resolve problems with the existing technology, wherein after streaming for 1 content file is all completed, one must request the Streaming Server for another session again in order to stream subsequent content files.

### TECHNICAL FIELD

The present disclosure pertains to a method of streaming content media files to a Portable Terminal and system thereof.

More specifically, in the event of streaming multiple content files in a mobile environment, this disclosure pertains to a method of combining multiple content files into one streaming file through Playlist Generator provided for the Streaming Server and then streaming the entire file at once to a Portable Terminal and system thereof in order to resolve problems with the existing technology, wherein after streaming for 1 content file is all completed, one must request the Streaming Server for another session again in order to stream subsequent content files.

### BACKGROUND INFORMATION

In step with the increase of Internet users and development of related technology, not only simple text-oriented data but also a variety of multimedia data are widely being processed over the web. Previously, an entire file had to be downloaded in order to replay multimedia data that is transmitted over the web, but in the case of large multimedia data, excessively long initial lag time was sited as a big problem. And although reliable transmission was guaranteed as TCP was used as the transmission protocol, there is a problem in that the time relationship among audio/video packets was being destroyed.

In order to address this problem, a streaming method and Transmission Protocol for real time data transmission were developed. The streaming method is a technique that receives transmission in small increments without downloading the entire file in order to reduce the playback lag time, but it became necessary to have a protocol that can send real time transmission even with some data loss for regular transmission. Hence, RTSP (Real Time streaming Protocol) that sets up and controls connection between the server and the client and adds a function of transmitting multimedia data with real time characteristics to HTTP's basic functions was standardized.

Accordingly, the user, when intending to obtain multimedia data over the web, first connects to the web server to receive information about the media, and then connects to the RTSP server to receive the Streaming Service of the media.

At first, in order to perform streaming, one needs to encode media files such as AVI (*.avi), and MPEG (*.mpeg, *.mp3) files in streaming file format. To execute streaming files over the web through the user's PC, programs such as Real Player of Real Network and Windows Media Player of Microsoft must be installed first. Real Media uses RM (*.rm) and meta file RAM (*ram) as the streaming file format while Windows Media uses WMA (*.wma) and WMV (*.wmv) and meta files, ASF (*.asf) and ASX (*.asx), etc.

However, in a mobile environment, the third generation standard 3GPP (the 3^{rd} Generation Partnership Project) (*.3gp) and 3GPP2 (the 3^{rd} Generation Partnership Project 2) (*.3g2) for speedy mobile data transmission in the Cellular Networks are each adopted in the transmission network respectively, and a similar standard to this was established.

FIG. 1 roughly illustrates overall streaming architecture.

Original media data that are provided or manufactured by Contents Providers (CP) are converted to 3GPP and 3GPP2 formats by the encoder; these converted media files are stored in the Streaming Server; and the Streaming Server streams media files through the transmission network to the Portable Terminal.

In general, the process in FIG. 2 demonstrates the streaming process more specifically.

For example, in order to send streaming to a Portable Terminal from the viewpoint of 3GPP in a mobile environment, first, convert the abc.avi file that can be played in Window Media Player for PC using an encoder to abc.3gp with appropriate bit rate, size, codec, and file format and compress media clips during this conversion process so that the original media data that require a large storage space can be easily transmitted through transmission channels such as low bit rate modem connection (S11).

Next, store converted files in media folder of the Streaming Server, for example, in the format of “C:\streaming\media\abc.3gp” (S12), generate links to applicable medias such as “rtsp://streaming.nextreaming.com/abc.3gp” (S13) so that the terminal gets connected to the Streaming Server to receive the Streaming Service, and put the applicable links on the Internet page of the website (Portal) (S14).

When the user of the Portable Terminal selects the above-referenced streaming link by visiting said website in the above using the terminal (S15), the terminal gets connected to the Streaming Server and starts the Streaming Service for abc.3gp file (S16).

But problems occur when streaming multiple contents of 2 or more, which is not the case when streaming 1 media content as described in the above.

FIG. 3 illustrates a method of streaming multiple media contents in general PC environments.

Let's assume a case where 3 streaming files (File1.3gp, File2.3gp, and File3.3gp) are streamed through a media player. First, you request a session for File1.3gp to play media of file1, but in order to play media of the file2, you need to sever the connection to File1.3gp session, and try to obtain connection to the File2.3gp file. In the same manner, in order to open the media file of file3, you need to discontinue the File2.3gp session and then try connecting to the File3.3gp file.

This problem of repetitive closing and opening does not seem to be pointed out as a huge problem in the PC environment. It doesn't take long to open and close a session; not only is it easy to implement an application that automatically resolves such issue but updates for such automatic solution can be easily done.

However, if you look at the case of FIG. 3 in a mobile environment, there is a problem where a handset player cannot automatically initialize a session. In most cases, a terminal is set up so that once the streaming of 1 file is complete, another request for content needs to be made once again and furthermore, it is not easy to repeat Step S15 every time. This is also illustrated in FIG. 4.

FIG. 5 illustrates an example of Pseudo Broadcast.

In the example of Pseudo Broadcast illustrated in FIG. 5, continuous streaming takes place into multiple terminals through Pseudo Broadcaster, and it looks as if multiple files of File1.3gp, File2.3gp, and File3.3gp are being streamed all at once. But in fact, each file not only has time continuity but there is also limitation for each terminal to see the same content at the same time.

In other words, even in the case of Pseudo Broadcasting, it is not possible for a terminal user to freely receive streaming of multiple content files.

### BRIEF SUMMARY OF THE INVENTION

The Inventor of the present invention, faced with problems of the existing art described in the above, set as one objective of the present invention, the provision of a streaming method that enables the user of a Portable Terminal to receive streaming of multiple contents all at once and a system for such a method.

Meanwhile, in order to achieve said objective, one is not to implement functions that achieve the objective within the terminal (it is not easy to build and inefficient since the specifications of each Portable Terminal maker are different). Rather, one should make it such a way that types and specifications of various terminals shall not pose restrictions by implementing the functions on the Streaming Server even though functions are not implemented on the terminal.

In addition, the present invention set, as another objective, the provision of various options that implement a business model by connecting advertisement methods or enable implementation of such conveniences as players used for PC in a Portable Terminal.

Other objectives and advantages of various embodiments of the present invention will be described below. We would like to add that the other objectives and strengths of the present invention will be accepted more widely not only by the matters described in the various embodiments and claims but also by the means and combinations that can be generated within the scope that can be easily considered, and it will correspond to the unique effect of an embodiment of the present invention.

An embodiment of the present invention, for the purpose of achieving such objectives, relates to a streaming method that enables streaming multiple content files all at once to a Portable Terminal without attempting to reconnect to each separate content, comprising:

The 1^{st} Step wherein 2 or more content files are selected;

The 2^{nd} Step wherein one Playlist file is generated for said content files via the Playlist Generator to prepare for Streaming Service;

And the 3^{rd} Step wherein the above-referenced Playlist files are streamed to a Portable Terminal.

In addition, it is desirable to include another step—Step 4 wherein real time update is applied to the Playlist during streaming into the Portable Terminal.

It would be desirable for the said 1^{st} Step of one embodiment of the present invention, wherein said content files are selected to be pre-established in Contents Provider (CP) or the web server.

And the 1^{st} Step, wherein said content files are selected in other forms of embodiments, can progress in an Interactive Mode whereby the Portable Terminal user connects to the website and directly prepares the Playlist.

And as embodiments for the 4^{th} Step, wherein said real time update is applied, in the event that the Portable Terminal user modifies, adds or deletes the Playlist that is being streamed through connection to the website, it would be advisable to perform an update in real time on the Playlist with the modified, added or deleted content list.

And it would be desirable for the 2^{nd} Step wherein said Streaming Service is being prepared to include:

A step wherein Validation Check is performed on content files that are selected during Step 1 by Playlist Generator;

A step wherein the Playlist is prepared;

A step wherein Playlist files are stored in a specific media folder of the Streaming Server;

And a step wherein a streaming link for said specific media folder is generated on the Internet page of the website.

Meanwhile, regarding the step where said Validation Check is performed, it can be understood as checking validity of each file's codec and encoding parameters for each codec in order to check if each file can be streamed as one file without any stoppage through the Streaming Server. Individual Validation Check can be performed for each file, or as an alternative method, the Validation Check can be performed on all the files at once.

It would be desirable for said Playlist files of one embodiment of the present invention to include sequence number, location information and option information for each file.

And it would be desirable for the 3^{rd} Step wherein files of the Playlist are being streamed to include the following:

A step wherein a streaming link is selected for the Playlist files by connecting to the Internet page of the website using the browser of the Portable Terminal;

A step wherein the Streaming Server streams above-referenced Playlist files as 1 file to the Portable Terminal without attempts to reconnect once the streaming link is selected.

In addition, said streaming link can be configured in such a manner that the Streaming Server includes another step that performs authentication in terms of the number of times or (and) specific time.

On the other hand, it is a good example of the embodiments of the present invention as a business model that said content files of one embodiment of the present invention include advertisement content files;

That the advertisement content files are combined with other content files and one Playlist file is generated through said Playlist Generator, and that advertisement content files and other content files are being streamed sequentially as one Playlist file to a Portable Terminal.

It would be desirable for the Playlist Generator that generates one Playlist during said Step 2 of one embodiment of the present invention, to be configured in a manner that sets up Random Access function which allows Random Access to content files of 1 or more contained in the Playlist.

For instance, it would be good to set up a prohibited area that prohibits Random Access in 1 or more pre-determined specific content files.

It would be desirable for the Playlist Generator that generates one Playlist during Step 2 of one embodiment of the present invention, to be configured in a manner that enables establishing of Track Move function which allows Track Move for 1 or more content file contained in the Playlist, or a prohibited area where Track Move is prohibited.

And, if said Playlist is audio, it would be considered a highly desirable execution format to display the information of the audio file on the liquid crystal of the Portable Terminal by generating video files that contain information about applicable audio files in advance and streaming corresponding video files while streaming the audio files.

The unique system of one embodiment of the present invention that makes it possible to implement the method of one embodiment of the present invention described so far relates to a streaming system that allows streaming multiple content files all at once without making attempts to reconnect for each content and has the following features;

Above-referenced content files are converted to streaming files by an encoder and the Streaming Server transmits the streamed files to a Portable Terminal;

In the event that above-referenced content files of N or more (N is an integer greater than 1) are selected, the Playlist Generator generates one Playlist for content files C₁, C₂, . . . , C_{N} (C refers to a content file, and its subscript is a random serial number, an integer greater than 1) targeted for streaming, puts information contained in each content file in the Playlist files and transmits them to a media folder of said Streaming Server and then links the media folder to an Internet website;

A Portable Terminal receives streaming of content files specified in said Playlist through a transmission network from said Streaming Service, after which it considers content files of N or more as one content file and completes the selection of a streaming link of said Internet website at one (1) time.

And the system of one embodiment of the present invention furthermore includes an Advertisement Server that provides advertisement contents;

Said Playlist Generator can combine advertisement contents that are provided by said Advertisement Server and stored in the Streaming Server with content files provided by said content server to generate Playlist files.

On the other hand, the Streaming Server includes Random Access Module and Track Move Module which allow Random Access to 2 or more content files and Track Move respectively, and it would be desirable to pre-establish Random Access Prohibition Area and (or) Track Move Prohibition Area depending on the types of said content files through the Playlist Generator.

And it is desirable for the system of one embodiment of the present invention to set an area where the bill payment processing is prohibited for certain contents with 1 or more content.

### BRIEF DESCRIPTION OF THE SEVERAL VIEWS OF THE DRAWINGS

FIG. 1 is a drawing that shows overall streaming architecture.

FIG. 2 is a flow chart that illustrates an existing mobile streaming procedure.

FIG. 3 is a drawing that illustrates composition of the Playlist in general PC players.

FIG. 4 is a drawing that illustrates problems in case of streaming multiple content files in a mobile environment.

FIG. 5 is a drawing that illustrates an example of existing Pseudo Broadcasting.

FIG. 6 is a drawing that illustrates overall system configuration in accordance with one embodiment of the present invention.

FIG. 7 is a drawing that shows functions of an embodiment of a Playlist Generator.

FIG. 8 is a flow chart that illustrates a method of streaming in accordance with one embodiment of the present invention.

FIG. 9 is a drawing demonstrating a case where the server selected contents at Step S100 of FIG. 8.

FIG. 10 is a drawing demonstrating a case where the user selected contents at Step S100 of FIG. 8 using a portal site.

FIG. 11 is a flow chart that illustrates detailed processes at Step S200 of FIG. 8 (In this drawing, Steps S210 and S220 can be performed at Step S100 of FIG. 8).

FIG. 12 is a flow chart that illustrates detailed processes of Step S300 of FIG. 8.

FIG. 13 is a drawing that illustrates an overall process of one embodiment of the present invention.

FIG. 14 is a drawing that illustrates an embodiment wherein advertisement contents are included in the Playlist.

FIG. 15 is a drawing that illustrates an example of billing strategy in the case of FIG. 14.

FIG. 16 is a drawing that shows functions of Random Access Module.

FIG. 17 is a drawing that shows setting of areas where Random Access to certain contents (for example, advertisement contents) is prohibited in the above-referenced case of FIG. 16.

FIG. 18 is a drawing that shows functions of Track Mobile Module.

FIG. 19 is a drawing that shows the setting of areas where Track Movement for certain contents (for example, advertisement contents) is prohibited in the above-referenced case of FIG. 18.

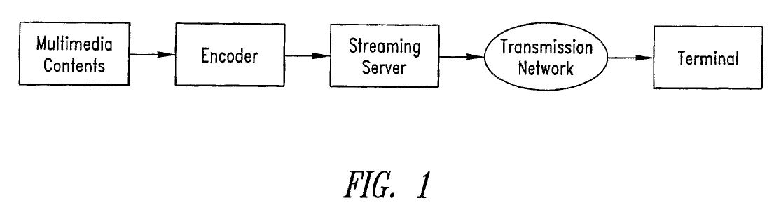

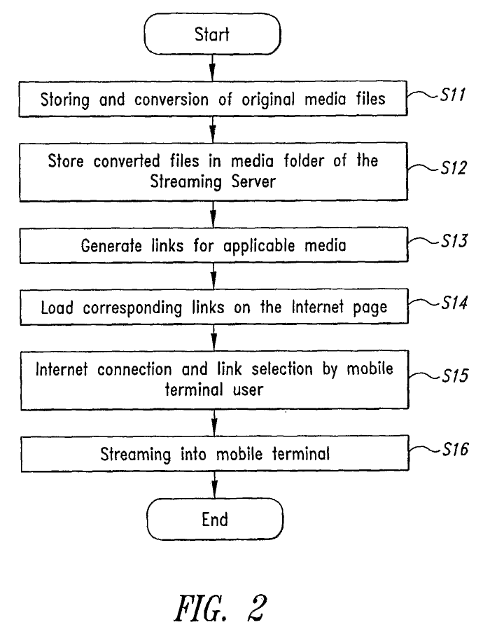

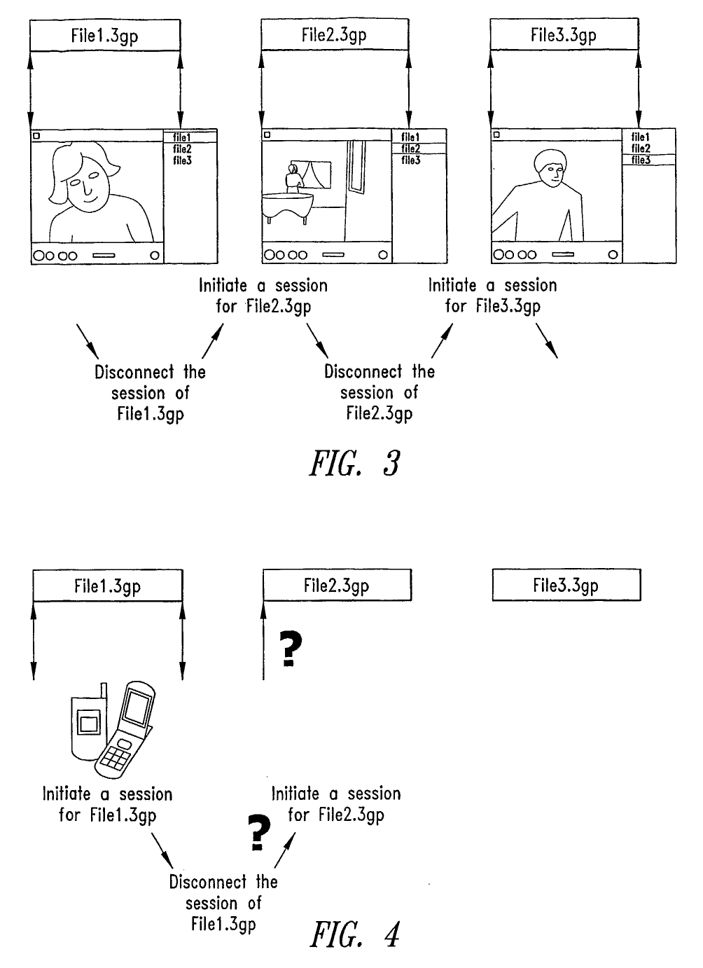

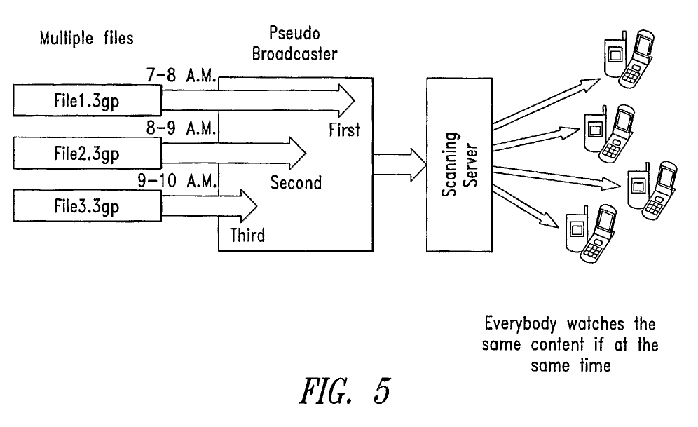

<We'd like to clarify that the above-referenced drawings are drawings for reference to an embodiment and as such are not to be considered as limiting.>

### DETAILED DESCRIPTION

We shall describe below in detail one or more embodiments in accordance with the present invention by making reference to attached drawings. In describing one embodiment of the present invention, in case any matter, such as a publicly disclosed function or construction that is obviously clear to whoever is familiar with this field, is mentioned, a detailed description of the matter shall be omitted.

In the following description, numerous specific details are given to provide a thorough understanding of embodiments. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

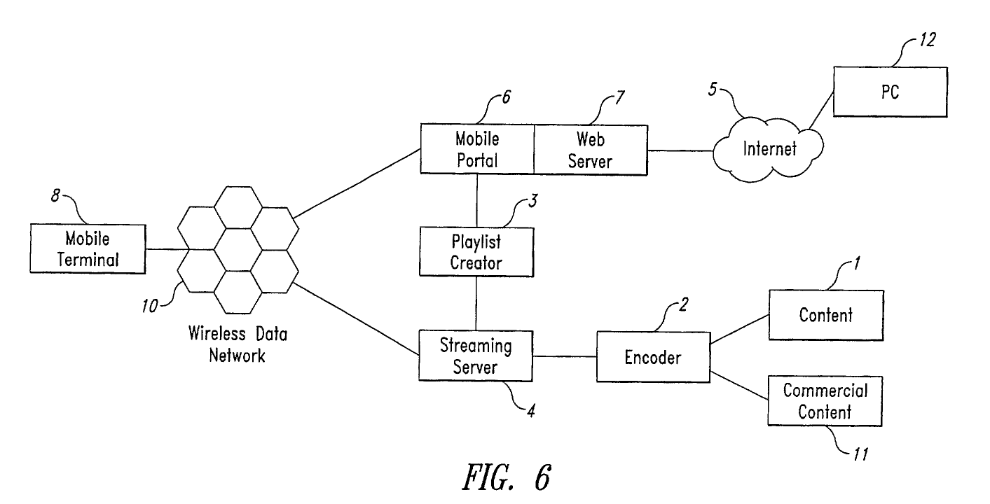

FIG. 6 concisely illustrates the system configuration of one embodiment of the present invention.

Encoder (2) converts original media data (1) of contents into streaming files and stores them in the Streaming Server (4). Playlist Generator (3) generates one (1) Playlist once checking codec type of each file is done, and then stores the Playlist in the Streaming Server (4) in preparation for streaming multiple contents all at once. Such preparation becomes complete as connection takes place through the wireless portal (6) that provides mobile pages that can be linked to the Streaming Server (4) and the wireless data network (10). On the other hand, the user of the Portable Terminal (8) selects a streaming link by connecting to the wireless portal (6), and streaming into the Portable Terminal (8) takes place through the wireless data network (for example, CDMA 2000 1x, EV-DO, GPRS, EDGE, etc.). The user of the Portable Terminal (8), before selecting the streaming link or while receiving the Streaming Service, can add or delete the Playlist in Interactive Mode by accessing the web server (7) that is connected to the Mobile Portal (6) through Internet (5) in the user's PC (12).

Meanwhile, conditions of the encoding profile that are used in order to put multiple content files (1) (11) into one Playlist are shown in the following table.

Type of codec contained in each content file are the same.

| | |
|---|---|
| MPEG-4 Visual | Decoder Specific Info. (Frame Size, Profile-level- |
| | id), Timescale, H, 263, Frame Size, Profile, Level, |
| | Timescale etc. are identical. |
| H.264 | PPS/SPS (Frame Size), Profile-level-id etc. are |
| | identical. |
| AAC-LC | Decoder Specific Info. (Sampling rate, Bit per |
| | sample, Channel Number) etc. are identical. |
| AMR, QCELP, | Sampling rate, Bit per sample, Channel Number, |
| EVRC | etc. are identical. |

And FIG. 7 shows the function of said Playlist Generator (3). According to FIG. 7, each separate content file (File1.3gp, File2.3gp, and File3.3gp) is placed in one Playlist through said Playlist Generator (3) and then these Playlist files are transmitted to the Portable Terminal (8) as one streaming file (Files.3gp), after which the Portable Terminal (8) recognizes this as one file and receives streaming as such.

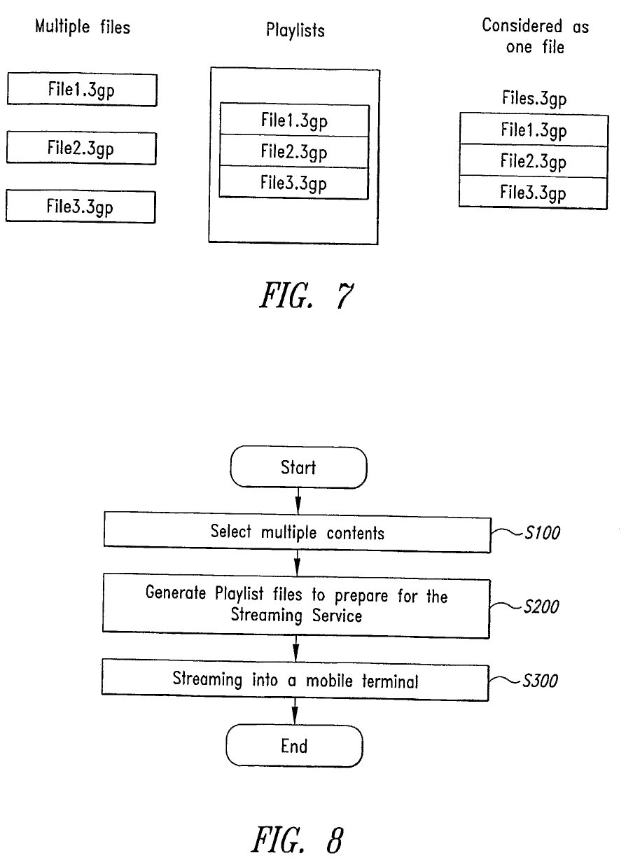

The system of one embodiment of the present invention includes the Playlist Generator in the Streaming Server (4) and FIG. 8 roughly illustrates the streaming method of one embodiment of the present invention utilizing the Playlist Generator.

To begin with, multiple content files will be selected (S100).

The selection of content files is either pre-determined in the web server of the Internet website (Portal) that provides contents or in the content server that provides contents to Internet websites, or pre-selected among the list of contents files that are placed on the website server as the user of the Portable Terminal connects to the website or in Interactive Mode. At this time, types and sequence of files shall be considered as well.

Next, it leads to a step where one Playlist file is generated for content files that are selected through the Playlist Generator in preparation for the Streaming Service (S200). For example, if we assume a scenario where the server selects File1.3gp and File 5.3gp; File1.3gp, File2.3gp, and File4.3gp; File2.3gp, File3.3gp and File5.3gp; File5.3gp, File3.3gp and File1.3gp from individual content files of File1.3gp, File2.3gp, File3.3gp,

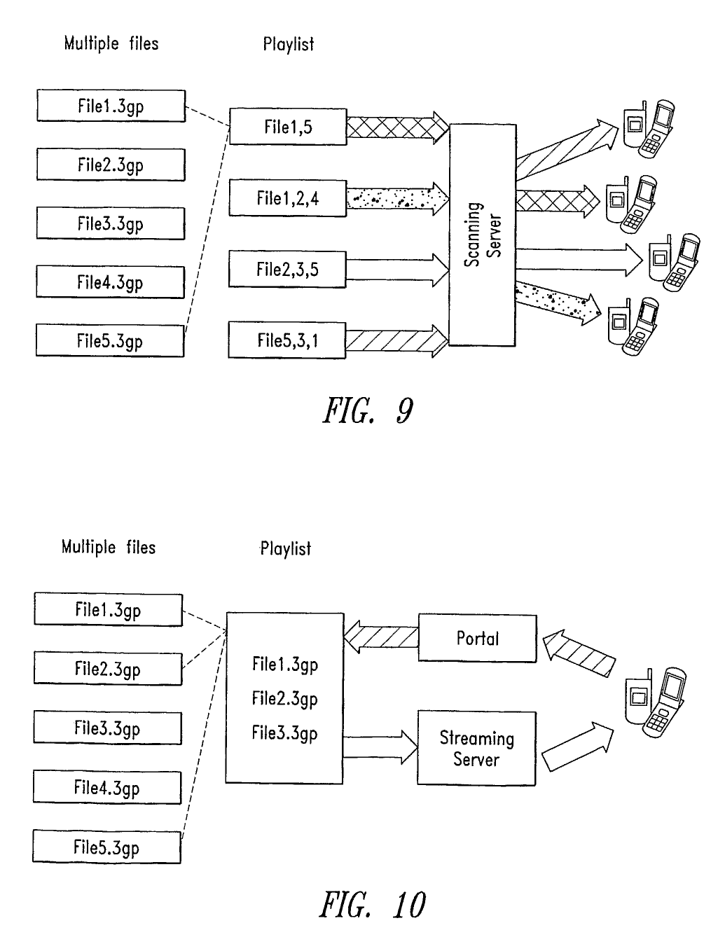

File4.3gp, and File5.3gp, Playlist Generator generates one Playlist file respectively from each selected group of files which are File1 and File5; File1, File2 and File4; File2, File3 and File5; and File5, File3 and File1. This individual group of Playlist files shall be recognized as one content and streamed as such. This step is illustrated in FIG. 7 and FIG. 9 that are already described above.

FIG. 10 illustrates a case where multiple contents are pre-selected by the user of the Portable Terminal using a portal site. If the user of the Portable Terminal selects, for example, File1.3gp, File2.3gp and File3.3gp, among multiple files that are linked, after connecting to the portal site using the Internet, the three files shall be designated as one Playlist and streamed as if they were one streaming file.

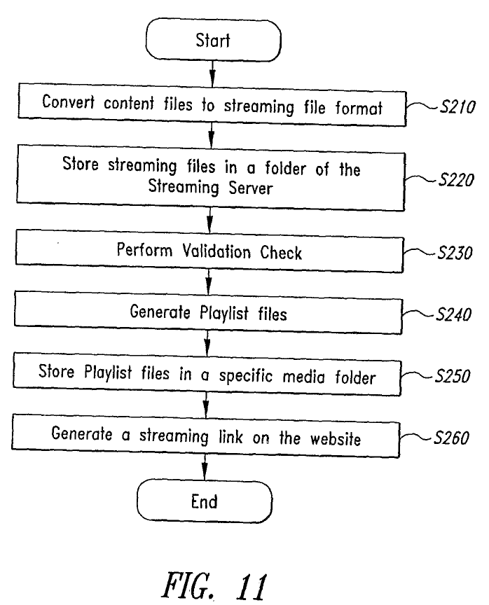

More specific processes of said Step S200 are illustrated in FIG. 11. Of these processes, Steps S210 and S220 were added for the sake of convenient explanation, and can be regarded as having already been carried out in the above Step S100.

To begin with, convert content files using an encoder into a streaming file format with appropriate bit rate and size and codec, etc. (S210). For instance, File1.avi, File2.wmv, and File3.asf are converted into File1.3gp, File2.3gp, and File3.3gp respectively. Next, streaming files are stored in the respective folder of the Streaming Server (S220). For instance, said converted files are designated as “C\:tempmedia\File1.3gp”, “C:\tempmedia\File2.3gp”, and “C:\tempmedia\File3.3gp”, and stored in the folder of the Streaming Server.

Above-referenced Steps S210 and S220 in this example of implementation do not need to be carried out from the beginning each time in order to perform Step S230 shown below and shall be understood as steps that were already performed in the past. It is because when the encoding process is inserted every time, the time taken to process the encoding becomes too long, which is not desirable for the system operation. In other words, Step S230 shown below shall be understood as being performed for files that are already encoded in the streaming format, and said Steps S210 and S220 should be regarded as having already been carried out in said Step S100 that selects 2 or more content files.

When content files are selected, Validation Check is performed on the selected files (S230).

In order to transmit multiple files continuously, files contained in the Playlist have the same codec, and the encoding parameter for each codec are similar. Hence, in case a Playlist is prepared, every time a file is added, one compares the applicable file to previous files to check if they have the same codec as well as encoding parameters within the allowed range and check the validity of the added files.

In other words, parameters for Validation Check for files are as follows.

1. The type of codec to be stored is identical for images and sounds.

2. When images are encoded in MPEC-4 Visual codec, the following parameters are identical:

Decoder Specific info. (Frame Size, profile-Level-id), Timescale, H.263, Frame Size, Profile, Level, Timescale

3. When images are encoded in H.264 codec, the following parameters are identical:

PPS/SPS (Frame Size)

Profile-Level-id

4. When voices are encoded in AAC codec, the following parameters are identical:

Decoder Specific info. (Sampling rate, bit per sample, Channel Number)

5. When voices are encoded in AMR, QCELP or EVRC codec, the following parameters are identical:

Sampling rate, Bit per sample, Channel Number

2 or more files that meet said parameters above can exist in one Playlist.

Although the above-referenced Validation Check is a check-up that is done every time a file is uploaded, there are special cases where it is necessary to perform overall Validation Check en masse on all files contained in the prepared Playlist. In such a case, by checking all files in the Playlist, you check the validity of files to see if the Playlist can be used. For example, in the above Interactive mode, if the subscriber selects one Playlist of the content file list, it would be desirable to perform Validation Check on the entire file list at once.

As described in the above, after performing Validation Check, in order to tie File1, File2 and File3 as one streaming file, a Playlist such as File1File2File3playlist.3gp shall be prepared and generated (S240). The Playlist file contains information such as location for each file etc., within the file.

When the Playlist is generated, for instance, it can have the following formats.

File Extension: 3gp

File contents

# Nextreamer playlist

[SequenceNumber]|[File Location]|[Option]

[SequenceNumber]|[File Location]|[Option]

[SequenceNumber]|[File Location]|[Option]

. . .

For example, the following examples can be prepared.

Playlist.3gp

# Nextreamer playlist

1|D:\Development\Media\file1.3gp|11

2|D:\Development\Media\file2.3gp|0

3|D:\Development\Media\file3.3gp|110

4|D:\Development\Media\file4.3gp|110

Playlist files can be composed of a header part that shows applicable files are Playlist files, and a part that shows sequence number and location of each file, and a part to which usage option about the applicable file can be added. The name of the extension of the Playlist shall be made identical with the name of the extension of regular content files in order to support existing standard terminals.

Through above-referenced options, various usage methods can be set up such as whether the Track Move function will be supported or prohibited and whether billing information will be stored or prohibited.

Next, the prepared Playlist file shall be stored in a specific media folder (S250). For example, it shall be stored as “C:\streaming\Media\Playlist\File1File2File3playlist.3gp” and uploaded onto the applicable link of the website as rtsp://streaming.nextreaming.com/File1File2File3playlist.3gp” to generate a streaming link (S260).

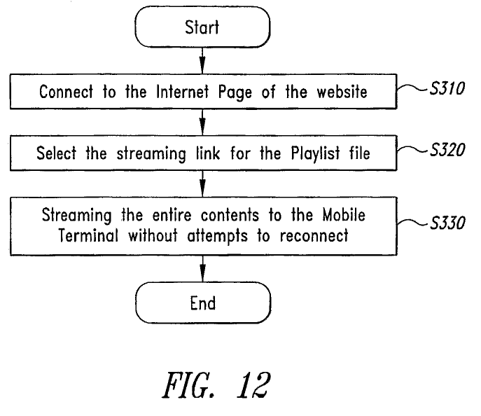

FIG. 12 illustrates more detailed processes of the above Step S300. The user of a Portable Terminal connects to the Internet page of the website through a wireless portal by using a browser (S310), and selects the streaming link linked to the Internet page, that is, “rtsp://streaming.nextreaming.com/File1File2File3playlist.3gp” (S320), so that the terminal connects to the Streaming Server, after which the Streaming Service commences accordingly (S330).

At this time, the Streaming Server automatically streams File1.3gp, File2.3gp, File3.3gp successively, and the terminal decompresses codec compression and play back the clips. Since the terminal recognizes the above-referenced files as one streaming file, it becomes impossible to tell if multiple files are streamed or a single file is streamed. Hence, this embodiment resolves a problem of having to connect to the web server several times in order to receive the streaming of all the content files.

FIG. 13 roughly illustrates, once again, the entire processes of FIG. 8, FIG. 11, and FIG. 12. The streaming that takes place in the order of File1.3gp, File2.3gp, File3.3gp removes the inconvenience of restarting a session since a session request for the Playlist stops after one time and the Portable Terminal recognizes all the files as one file. The Streaming Server automatically conducts streaming and only after streaming of all files contained in the Playlist is complete, does the session of the Playlist stop.

Meanwhile, it is also possible to apply real time update to the Playlist during the streaming into the Portable Terminal.

As already explained in the above, according to one embodiment of the present invention, it is possible for a service user to generate or modify the Playlist in Interactive Mode through a portal page and receive streaming of the user's Playlist in real time. In case of generating or modifying the Playlist, Validation Check mentioned in the above shall be performed.

In case a specific Playlist file is streamed, the Streaming Server reads the Playlist, every time the content is transitioned into the next content, and checks the location and option information before starting streaming. Therefore, if a specific content of the Playlist is being played, subsequent contents may be deleted from the list or other contents can be added during the play. In such a case, the Streaming Server can stream subsequent contents based on the modified Playlist.

The Streaming Server does not take into consideration change in a file that has already been played and takes the sequence number contained in the Playlist as the criteria for judging if a file that is already played has been modified. For instance, when there is the following Playlist,

# Nextreamer playlist

1|D:\Development\Media\file1.3gp|11

2|D:\Development\Media\file2.3gp|0

3|D:\Development\Media\file3.3gp|110

4|D:\Development\Media\file4.3gp|110

Assuming the Streaming Server is playing #2, if the contents are modified as follows during the play,

# Nextreamer playlist

1|D:\Development\Media\file1.3gp|11

2|D:\Development\Media\file2.3gp|0

3|D:\Development\Media\file5.3gp|110

4|D:\Development\Media\file6.3gp|110

5|D:\Development\Media\file7.3gp|110

afterwards, the Streaming Server streams file5.3gp. If the Playlist is modified as follows while #3 is being played,

# Nextreamer playlist

1|D:\Development\Media\file2.3gp|0

2|D:\Development\Media\file5.3gp|10

3|D:\Development\Media\file6.3gp|110

4|D:\Development\Media\file7.3gp|110

the Streaming Server is not concerned about the modification of #1, 2, and 3 and streams the content of #4.

The process during which such real time update takes place can be understood in Interactive Mode wherein if the user of the Portable Terminal, in the middle of receiving streamed files, modifies, adds or deletes the content list of the Playlist which is being streamed after the user is connected to the website, and while the user is in the process of receiving streaming, events of modification, addition, and deletion occur; and the modified, added and deleted content list is streamed in accordance with such events.

And, even in the case where the content list of the Playlist, the target of real time update, is modified or added, said Validation Check procedure shall be performed separately on the newly updated content.

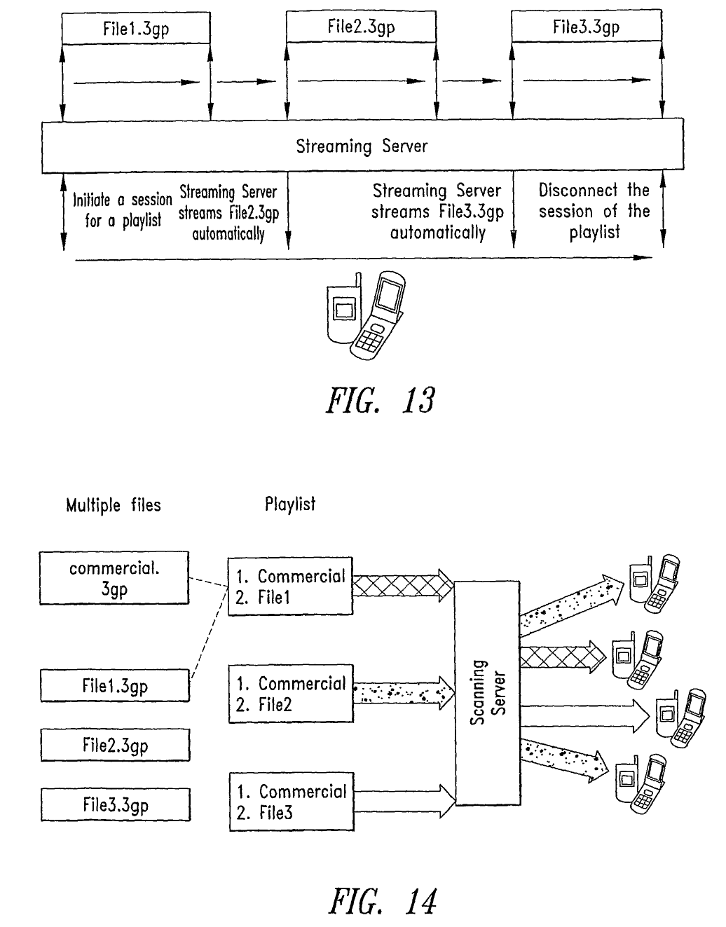

On the other hand, in the embodiment of FIG. 14, said content files include advertisement content files. In such a case, selection of the advertisement content shall be determined in the web server or the Streaming Server rather than by the selection of the terminal. Playlist Generator combines File1.3gp, File2.3gp, and File3.3gp that contain general contents with commercial.3gp that contains advertisement contents respectively to form CommercialFile1, CommercialFile2 and CommercialFile3 respectively. In the event that the Streaming Server streams such files by transmitting them to a Portable Terminal, in the case of CommercialFile1, Commercial.3gp is streamed first and then File1.3gp; in case of CommercialFile2, Commercial.3gp is streamed first and then File2.3gp; and in case of CommercialFile3, File3.3gp is automatically streamed after streaming of Commercial.3gp is all complete. In other words, in the above embodiment, advertisement effects of the advertiser can be maximized by making streaming of advertisement contents mandatory in order to receive streaming of any one of File1, File2, and File 3. In such a case, it would be desirable to process bill payment only when general content files are being streamed as shown in FIG. 15, and in case of advertisement contents, it is advised that the streaming time should be excluded from the total billing, because they are not selected by the user of the terminal.

Of course, advertisement DB and a server for bill processing for such an embodiment shall be provided on the system level.

As shown in the above, in terms of specific contents within the Playlist, a portion corresponding to applicable contents can be omitted when data for billing is stored depending on the intention of the service provider. Data for billing can include, for instance, the number of packets transmitted, names of content files for billing, or playback time of a played file.

We believe that the idea of one embodiment of the present invention should not be limited to the Playlist Generator combining and streaming multiple streaming files as one Playlist but it should also create a streaming solution that is more suitable to the user's usage. Multiple streaming files for each separate content exists within one Playlist and since they are streamed as if they were one file, the user's terminal does not recognize them as multiple streaming files but as one single streaming file. However, since Playlist files are distinguished as separate multiple streaming files in reality, there is a necessity for a module that enables the user of a Portable Terminal to have access to an individual streaming file.

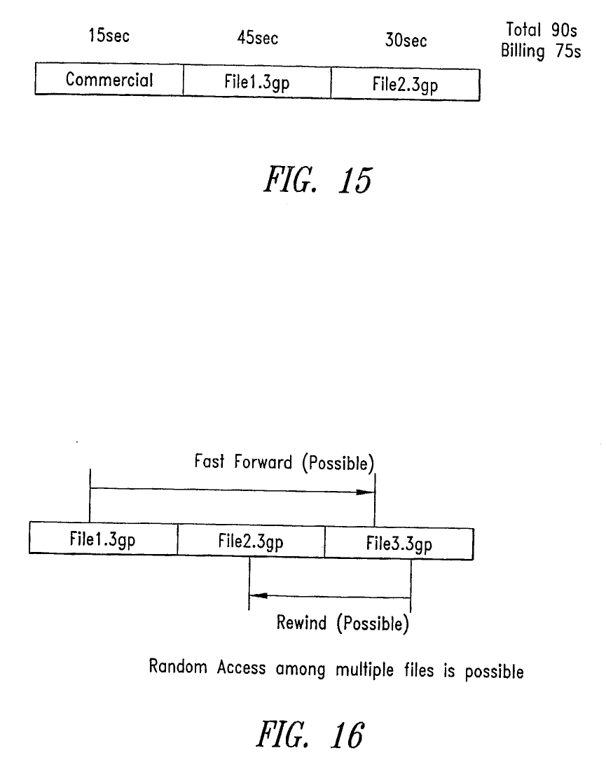

To this end, as shown in FIG. 16, above-referenced Playlist Generator is configured with Random Access Module that enables random access to contents files (File1.3gp, File2.3gp, and File3.3gp) contained in the Playlist, Hence, for instance, while playing back the content of File1.3gp, the user can access File3.3gp (Fast Forward), or while playing back content of File3.3gp, you can access in reverse (Rewind) and play back the content of File2.3gp.

On the other hand, specific contents can be set aside in an area where random access is prohibited. For example, in case the function of Random Access Module is applied to the embodiment of FIG. 13, since it is desirable to set advertisement contents to be force streamed into the user's Portable Terminal, it is recommended that random access to advertisement contents be prohibited. As such, when storing and managing the Playlist, it can be set up in a way that multiple tracks to which random access is banned are added to random positions. The Streaming Server prohibits the user from using the function of Track Move when encountering a track prohibited for random access while streaming the contents in the Playlist one by one. This is identical to the Track Move Module mentioned below.

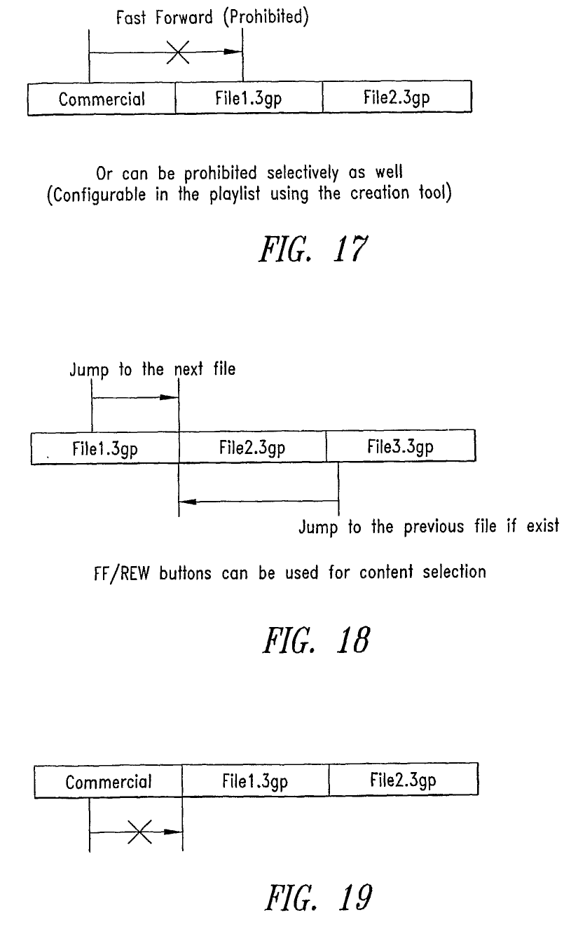

In other words, as illustrated in FIG. 17, the system shall be set up in a way that prohibits random access to Commercial contents and makes sure to stream the commercial contents without fail. We shall add that of course, such prohibited areas are not limited to advertisement contents and can be pre-determined in various ways; said Random Access module is modulized with software within said Streaming Server and use of applicable options can be set up in Playlist Generator, which is also applied to the Track Move module below.

In addition, FIG. 18 illustrates an embodiment wherein the Track Move function is set up in said Playlist Generator. This function works in a way that while streaming File1.3gp content, the Playlist jumps forward to stream File2.3gp or while streaming File3.3gp, it jumps backwards to stream File1.3gp by allowing Track Move for 2 or more content files contained in the Playlist. In short, when the Playlist jumps forward while streaming File2.3gp, it should move to the starting point for File1.3gp of the previous step, not the starting point where File2.3gp starts. If there is no file in the previous step, the Track Move function can be configured in a way that the Playlist can move to the starting point of File2.3gp that is being streamed.

For example, it allows Track Move for content files of 1 or more contained in the Playlist by recognizing Forward or Backward button selection implemented in the Streaming Player of the Portable Terminal as Move to the Previous Track or Move to the Next Track. This is to technologically overcome situations where UI for Track Move does not exist in standard terminals, and this function is implemented in the Streaming Server in a way that when Move Forward or Move Backward button is selected in the terminal, this command is recognized as Move One Track Forward or Move One Track Backward. In other words, despite the fact that there is no UI for Track Move, it is possible to implement to use Forward and Backward buttons as UI for Track Move.

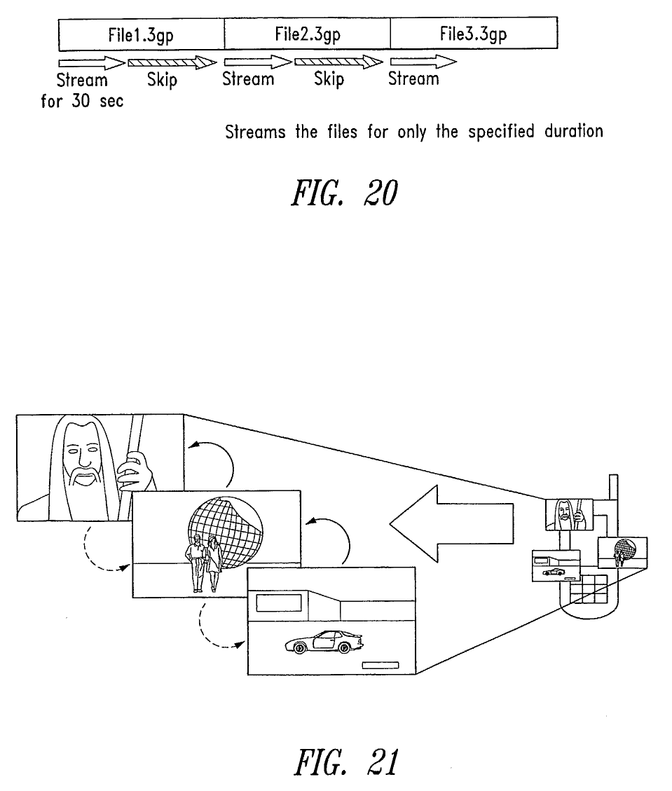

And in the case of the embodiment of FIG. 18, prohibited areas can be established for specific contents. Such an embodiment is illustrated in FIG. 19 and this corresponds to the case of FIG. 17. In other words, Commercial contents are configured in a way that they are streamed to the Portable Terminal, and while Commercial contents are being streamed, Track Move to the next content is prohibited.

And, in the event that said Playlist is Audio, one can display the information about the audio files in the liquid crystal display of the Portable Terminal by generating video files recorded with corresponding audio files in advance, and streaming the corresponding video files while the audio files are being streamed. In other words, if content files are Audio, each meta information is displayed as video, and audio is streamed to the Portable Terminal, in which case, it is necessary to manage the video separately. For example, you can store video files that contain information about each audio file in the Playlist, or let the Playlist decide the location of the video files; in case the Streaming Server performs streaming of applicable audio files, you can have corresponding video files streamed at the same time in order to display the information about the audio simultaneously through the screen of the Portable Terminal. To do this, the Streaming Server is able to open and stream both image and sound simultaneously for one streaming, and the Streaming Server repeats the playback by providing the standard for the playtime of a sound file regardless of the length of the image file or provides a function whereby streaming can be stopped halfway.

Meanwhile, in case of a standard mobile terminal, there is no way to receive the transmission of user authentication information through the standard streaming protocol. In such a case, the Streaming Server can protect the streaming link for the Playlist so that only the user can use it. The portal server receives a streaming link that is valid for a specific duration of time and a specific number of times from the Streaming Server before showing the Streaming Server to the user.

The user connects to the Streaming Server through the applicable streaming link while the Streaming Server checks the validity of the Playlist link and starts or denies streaming. Once the pre-defined specific number of times or specific time period passes, the corresponding Playlist link becomes no longer valid (Authentication of the Playlist).

In one embodiment, server side duration control is provided. That is, with some embodiments, playing duration is not able to be set in the playlist. The streaming server of these embodiments streams the entire duration of every content file in a playlist.

However, in other embodiments, playing duration can be set in the playlist file. If duration is set in a content file in the playlist, the streaming server will stream only the specified duration of a content file in a playlist and will skip the rest part. This concept is illustrated in FIG. 20.

For this change, the playlist format is changed to indicate the streaming duration of each content file as in the below example:

# XenonStreamer playlist
[SequenceNumber] | [File location] | [Option] | [Duration]
[SequenceNumber] | [File location] | [Option] | [Duration]
[SequenceNumber] | [File location] | [Option] | [Duration]

In this format, duration can be set as in the below example:

[Duration]: [start_time]-[end_time]
The unit of start_time and end_time is second.
If start_time is equal to zero, it can be omitted.
If end-time is omitted, it means ‘the end of the content’.
If [Duration] is omitted, it means ‘entire content’.

There are various uses for this duration control feature. For instance, the feature can be used to provide a preview in the streaming service: an existing piece of content can be used if a selected part can be streamed in the playlist. The example below shows how the first 30 seconds of a song can be streamed for preview purposes:

preview_song.3gp
# XenonStreamer playlist
1 | c:\media\song1.3gp | 1 | -30

The example below shows how 00:30-00:40+1:10-1:20+1:50-2:00 (total 30 seconds) can be streamed for preview:

preview_song.3gp
preview_video.3gp
# XenonStreamer playlist
1 | c:\media\video.3gp | 1 | 30-40
2 | c:\media\video.3gp | 1 | 70-80
3 | c:\media\video.3gp | 1 | 110-120

As another use of the duration control feature, if a content file is very long, its content can be divided into multiple links by specifying duration. The following example shows how a 7-minute content can be divided into two 2-minute content links and one 3-minute content link:

long_part1.3gp (2 mins)
# XenonStreamer playlist
1 | c:\media\long.3gp | 1 | 0-120
long_part2.3gp (2 mins)
# XenonStreamer playlist
1 | c:\media\long.3gp | 1 | 120-240
long_part3.3gp (the rest)
# XenonStreamer playlist
1 | c:\media\long.3gp | 1 | 240-

Yet another possible use of the duration control feature is to add an advertising clip in the middle of a content using playlist. The following example shows how an advertising content file is added after a one-minute playing of a content file, and the rest of the content file is played after the advertising content:

ad_inserted.3gp (the rest)
# XenonStreamer playlist
1 | c:\media\content.3gp | 1 | -60
2 | c:\media\ad.3gp | 1|
3 | c:\media\content.3gp | 1 | 60-

Another embodiment provides a live channel change feature. That is, in some embodiments, live streaming session cannot inserted. However, in other embodiments, multiple live streaming sessions can be inserted without duration information.

In this case, the track move function will works as “channel change” function. On request of this kind of playlist, the streaming server will stream the first live channel in a playlist. And if a random access request is detected, the streaming server streams the previous or the next live channel in the playlist as it works for the “track move” function. This concept is illustrated in FIG. 21.

If the streaming server streams a live session, the random access buttons can be disabled in a handset player. To activate the random access buttons in the handset player, the streaming server can stream a live channel in a playlist as a very long file.

The example below shows a playlist for live channel change:

multi-channels.3gp
# XenonStreamer playlist
1 | rtsp://1.1.1.1/live_channel1.3gp
2 | rtsp://1.1.1.1/live_channel2.3gp
3 | rtsp://1.1.1.1/live_channel3.3gp

On request of this kind of playlist, the streaming server starts streaming live channel1 at first. And, if a user selects ‘Fast forward’, the streaming server will stream live channel2 in the same RTSP session.

The live channel change feature can increase users' satisfaction because of the improved speed and convenience. A user can also configure his/her own channel list.

Once again, we would like to add that those embodiments are mere examples of the present invention. The scope of protection of the present invention shall not be limited by these embodiments. Various technical standards are available for the methods and system of embodiments of the present invention and it is easy to substitute and change the technical means to provide yet other embodiments. In addition, the scope of protection of the present invention cannot be limited by such obvious change or substitution.

According to one embodiment of the invention that has been described so far, Playlist Generator generates one Playlist and streams it to a Portable Terminal so that the user of the Portable Terminal can receive multiple contents all at once, thereby technologically promoting convenience of the user of a Portable Terminal. Through this, we can expect that supply and consumption of contents by the Portable Terminal will increase.

In addition, there is an advantage of increasing the effects of the advertisement that comes from generating the Playlist by combining various advertisement contents and general contents.

Moreover, special modules as options were added as embodiments to enable Random Access and Track Move, etc.

Furthermore, the effects of one embodiment of the present invention are not provided within the terminal but implemented on the Streaming Server, thereby optimizing the function of the Playlist files regardless of the specification and type of terminal. In another embodiment, components or other functionality may be provided within the terminal of the user.

We would like to add that the effect of one embodiment of the present invention will be accepted more widely not only by the matters described in the embodiment and claims, but also by the effect that can be generated within the scope that can be easily considered and the possibility of the advantages that contribute to the development of the industry.

The above description of illustrated embodiments, including what is described in the Abstract, is not intended to be exhaustive or to limit the invention to the precise forms disclosed. While specific embodiments and examples are described herein for illustrative purposes, various equivalent modifications are possible within the scope of the invention and can be made without deviating from the spirit and scope of the invention.

These and other modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

1. A streaming method that can be implemented on a streaming server and that allows streaming of multiple content files at once, without attempting to reconnect to said streaming server to establish a separate session for each content file to be sent to a portable terminal, when multiple files are transmitted to the portable terminal from the streaming server, the method being for streaming of multiple files through a playlist file in a mobile environment, the method comprising:
selecting 2 or more content files;
generating one playlist file for said content files via a playlist generator to prepare a streaming service; and
streaming said content files on the playlist file to the portable terminal as one file.

2. The method of claim 1 for streaming multiple files through the playlist file in the mobile environment, further comprising applying a real time update to the playlist file during streaming to the portable terminal.

3. The method of claim 1 wherein said selecting said content files set up in a content provider or web server that provides content files.

4. The method of claim 1 wherein said selecting said content files takes place in an interactive mode where a user of the portable terminal selects at least one file among the content files after connecting to a website.

5. The method of claim 2 wherein said applying the real time update includes in an event that a user of the portable terminal, in a middle of receiving streamed files, modifies, adds or deletes a content list of the playlist file which is being streamed after the user connects to a website, the modified, added, and deleted content list is streamed.

6. The method of claim 1 wherein said preparing said streaming service comprises:
performing a validation check on content files that are selected by the playlist generator;
preparing the playlist file;
storing playlist files in a specific media folder of the streaming server; and
generating a streaming link for said specific media folder on an Internet page of a website.

7. The method of claim 6 wherein said performing said validation check includes validating a codec of each file and encoding a parameter of each codec.

8. The method of claim 7 wherein said performing said validation check includes performing a validation check on each file individually or collectively.

9. The method of claim 6 wherein said playlist file includes a sequence number, location information, and option information.

10. The method of claim 1 wherein said streaming said content files on the Playlist as one file includes:
selecting a streaming link for the playlist file by connecting to an Internet page of a website using a browser of the portable terminal; and
wherein said playlist file is streamed as one file to the portable terminal without attempts of reconnection as said streaming link is selected, in said mobile environment.

11. The method of claim 10 for streaming multiple files through the playlist file in the mobile environment, further including the streaming server providing authentication for said streaming link in terms of a specific number of times in which said streaming link can be used by a user of said portable terminal to remain valid and/or a specific duration of time in which said streaming link is valid.

12. The method of claim 1 wherein said content files include advertisement content files, wherein the advertisement content files are combined with other content files to generate said playlist file through said playlist generator, and wherein advertisement content files and other content files are streamed sequentially as one playlist file to the portable terminal, in said mobile environment.

13. The method of claim 1 wherein the playlist generator that generates said one playlist, in said mobile environment, can set up a random access function that allows a user of the portable terminal random access to at least one of said content files contained in the playlist file.

14. The method of claim 13, further comprising in the mobile environment, setting up a prohibited area that bars random access by the user of the portable terminal to at least one of said content files.

15. The method of claim 1 wherein the playlist generator that generates said one playlist file is adapted to set up a track move function that allows a track move by a user of the portable terminal for at least one of said content files contained in the playlist file.

16. The method of claim 15 wherein the playlist generator sets up a prohibited area that prohibits said track move by the user of the portable terminal in at least one of said content files contained in the playlist file.

17. The method of claim 1 wherein information about audio files is displayed on a display screen of the portable terminal, in an event that said playlist file is audio, by generating video files recorded with information about corresponding audio files in advance, the method further including streaming corresponding video files while streaming the audio files.

18. The method of claim 1, further comprising:
providing a user of the portable terminal with duration control feature; and
providing said user of the portable terminal with a live channel change feature.

19. A streaming system that streams multiple content files at once without attempting to reconnect for each individual content file, the system comprising:
an encoder to convert said content files to streaming files;
a streaming server to transmit the streaming files converted by said encoder to a portable terminal;
a playlist generator, in an event that said content files of N or more, wherein N is an integer greater than 1, are selected, to generate one playlist file for content files C₁, C₂, . . . , C_{N}, wherein C refers to a content file and its subscript is a random serial number that is an integer greater than or equal to 1, targeted for streaming, and to put information contained in each content file in the playlist file, to transmit the playlist file to a media folder of said streaming server and to link the media folder to an Internet website; and
a portable terminal to receive streaming of content files that are displayed in said playlist file through a transmission network from said streaming server, wherein content files of N or more are transmitted as one playlist file in response to complete selection of a streaming link of said Internet website after one time, thereby allowing streaming multiple files through the playlist file in a mobile environment.

20. The system of claim 19 to stream multiple files through the playlist file in said mobile environment, further comprising an additional advertisement server to provide advertisement content files, wherein said playlist generator is adapted to combine advertisement content files that are provided from said advertisement server and stored in the streaming server with content files provided from a content server in order to generate the playlist file.

21. The system of claim 19 wherein said streaming server includes a random access module and track move module to enable random access and track move by a user of the portable terminal for at least one of said content files contained in the playlist file respectively, the streaming server being adapted to pre-establish a random access prohibition area and/or a track move prohibition area through playlist file depending on types of said content files.

22. The system of claim 19 wherein the system is adapted to prohibit bill payment processing for certain at least one of said content files.

23. The system of claim 19 wherein the playlist generator further includes a duration control feature and a live channel change feature usable by a user of the portable terminal.

24. A streaming server for streaming multiple content files in a mobile environment, the streaming server comprising:
means for selecting 2 or more content files;
playlist generator means for generating one playlist file for said content files; and
means for streaming multiple ones of said content files on the playlist file to a portable terminal as one file, without reconnecting to said streaming server to establish a separate session for each content file to be sent to said portable terminal in said mobile environment.

25. The streaming server of claim 24, further comprising:
duration control means for controlling playing duration of each content file in said playlist; and
live channel change means for permitting change in streaming of live channels.

26. The streaming server of claim 24 wherein said means for selecting is interactive to enable the portable terminal to select at least one file among the content files after connection.

27. The streaming server of claim 24, further comprising means for applying a real time update to said playlist file if the portable terminal, in a middle of receiving streamed files, modifies, adds or deletes a content list of the playlist file which is being streamed after connection, to enable the thus updated playlist file having said modified, added, and deleted content list to be streamed.

28. The streaming server of claim 24 wherein:
said playlist generator means can set up a random access function that provides the portable terminal with random access to at least one of said content files contained in the playlist file;
said playlist generator means can set up a track move function that allows a track move by the portable terminal for at least one of said content files contained in the playlist file; and
said playlist generator means can set up a prohibited area that prohibits said track move by the portable terminal in at least one of said content files contained in the playlist file.

29. The streaming server of claim 24, further comprising:
means for setting up a prohibited area that bars random access by the portable terminal to at least one of said content files.

30. An article of manufacture, comprising:
a computer-readable medium storing a computer program that is executable by a processor to stream multiple content files in a mobile environment, by:
selecting 2 or more content files;
generating one playlist file for said content files using a playlist generator; and
streaming multiple ones of said content files on the playlist file to a portable terminal as one file, without reconnecting to said streaming server to establish a separate session for each content file to be sent to said portable terminal in said mobile environment.

31. The article of manufacture of claim 30 wherein the computer program is further executable by the processor to:
control playing duration of each content file in said playlist; and
enable live channel change in streaming of live channels.

32. The article of manufacture of claim 30 wherein the computer program is further executable by the processor to:
provide interactivity to the portable terminal to select at least one file among the content files after connection;
apply a real time update to said playlist file if the portable terminal, in a middle of receiving streamed files, modifies, adds or deletes a content list of the playlist file which is being streamed after connection, to enable the thus updated playlist file having said modified, added, and deleted content list to be streamed; and
set up a prohibited area that bars random access by the portable terminal to at least one of said content files.

33. The article of manufacture of claim 30 wherein said computer program is executable by said processor to control said playlist generator to:
set up a random access function that provides the portable terminal with random access to at least one of said content files contained in the playlist file;
set up a track move function that allows a track move by the portable terminal for at least one of said content files contained in the playlist file; and
set up a prohibited area that prohibits said track move by the portable terminal in at least one of said content files contained in the playlist file.
